(19) United States
(12) Patent Application Publication
(10) Pub. No.: US 2022/0381189 A1
(43) Pub. Date: Dec. 1, 2022

(54) INTAKE AND EXHAUST VALVE CONTROL STRATEGIES TO REDUCE NOISE/VIBRATION/HARSHNESS DURING ENGINE STOP/START EVENTS

(71) Applicants: Amit Shrestha, Troy, MI (US); Fadi Estefanous, Troy, MI (US); Lurun Zhong, Troy, MI (US); Michael Barkey, Maidstone (CA); Benjamin T Dean, Rochester Hills, MI (US); Ethan E Bayer, Lake Orion, MI (US)

(72) Inventors: Amit Shrestha, Troy, MI (US); Fadi Estefanous, Troy, MI (US); Lurun Zhong, Troy, MI (US); Michael Barkey, Maidstone (CA); Benjamin T Dean, Rochester Hills, MI (US); Ethan E Bayer, Lake Orion, MI (US)

(21) Appl. No.: 17/330,627

(22) Filed: May 26, 2021

(51) Int. Cl. F02D 13/02; F02D 41/14; F02D 41/06; F02D 41/04

(52) U.S. Cl. CPC F02D 13/0207; F02D 41/1497; F02D 41/062; F02D 41/042; F02D 2200/024

(57) ABSTRACT

A stop/start system and method for an engine of a vehicle include a valve control system configured for full lift control of respective intake and exhaust valves of a plurality of cylinders of the engine and a controller of the engine configured to perform an engine stop event including initiating a fuel shutoff (FSO) event whereby fueling to the engine is disabled and the engine fully stops after a stop period and, in response to initiating the FSO event, commanding the valve control system to close each intake valve prior to closing its respective exhaust valve to (i) expel any residual gases from the cylinders during respective exhaust strokes prior to closing the respective exhaust valves, and (ii) prevent air-only intake and compression within the cylinders during the stop period to thereby mitigate or eliminate noise/vibration/harshness (NVH) caused by the air-only intake and compression.

### FIELD

The present application generally relates to engine stop/start control and, more particularly, to techniques for controlling intake and exhaust valves to reduce noise/vibration/harshness (NVH) during engine stop/start events.

### BACKGROUND

Engine stop/start is one of a plurality of strategies used to increase vehicle fuel economy. This generally involves the engine being periodically shutoff when positive drive torque is not being requested and then being restarted when needed. A conventional engine stop event typically comprises a fuel shutoff (FSO) event that causes the engine to fully stop (i.e., zero crankshaft rotation) after a period of time. Intake and exhaust valve lifts are a function of the engine speed and thus they operate (after the initiation of the FSO event) until the engine speed reaches zero, after which they only begin moving again upon a subsequent engine start. Because these valves continue moving during the FSO event, at least some cylinders experience an air-only intake and compression event. This compression causes a rise in cylinder gas pressure, and these “compression bumps” could result in noise/vibration/harshness (NVH) or engine jerk that is noticeable to a driver of the vehicle. Accordingly, while these conventional engine stop/start control systems do work well for their intended purpose, there exists an opportunity for improvement in the relevant art.

### SUMMARY

According to one example aspect of the invention, a stop/start system for an engine of a vehicle is presented. In one exemplary implementation, the stop/start system comprises a valve control system configured for full lift control of respective intake and exhaust valves of a plurality of cylinders of the engine, and a controller of the engine configured to perform an engine stop event including initiating a fuel shutoff (FSO) event whereby fueling to the engine is disabled and the engine fully stops after a stop period, and in response to initiating the FSO event, commanding the valve control system to close each intake valve prior to closing its respective exhaust valve to (i) expel any residual gases from the cylinders during respective exhaust strokes prior to closing the respective exhaust valves, and (ii) prevent air-only intake and compression within the cylinders during the stop period to thereby mitigate or eliminate noise/vibration/harshness (NVH) caused by the air-only intake and compression.

In some implementations, the commanding of the valve control system comprises closing each exhaust valve after the exhaust stroke of its respective cylinder. In some implementations, the commanding of the valve control system comprises fully closing the intake valves followed by fully closing the respective exhaust valves for the remainder of the stop period until the engine stop event is complete. In some implementations, the NVH is caused by engine jerk corresponding to cylinder pressure increases caused by the air-only intake and compression. In some implementations, the controller is further configured to perform an engine start event after the engine stop event by initiating a fueling event whereby fueling to the engine is enabled and the engine starts and its speed increases to an idle speed over a start period, and in response to initiating the fueling event, commanding the valve control system to control the intake/exhaust valves of the cylinders to mitigate or eliminate NVH caused by engine jerk over the start period.

According to another example aspect of the present invention, a valve control method for stop/start events of an engine of a vehicle is presented. In one exemplary implementation, the method comprises providing a valve control system configured for full lift control of respective intake and exhaust valves of a plurality of cylinders of the engine and performing, by a controller of the engine, an engine stop event including initiating an FSO event whereby fueling to the engine is disabled and the engine fully stops after a stop period and, in response to initiating the FSO event, commanding the valve control system to close each intake valve prior to closing its respective exhaust valve to (i) expel any residual gases from the cylinders during respective exhaust strokes prior to closing the respective exhaust valves, and (ii) prevent air-only intake and compression within the cylinders during the stop period to thereby mitigate or eliminate NVH caused by the air-only intake and compression.

In some implementations, the commanding of the valve control system comprises closing each exhaust valve after the exhaust stroke of its respective cylinder. In some implementations, the commanding of the valve control system comprises fully closing the intake valves followed by fully closing the respective exhaust valves for the remainder of the stop period until the engine stop event is complete. In some implementations, the NVH is caused by engine jerk corresponding to cylinder pressure increases caused by the air-only intake and compression. In some implementations, the method further comprises performing, by the controller, an engine start event after the engine stop event by initiating a fueling event whereby fueling to the engine is enabled and the engine starts and its speed increases to an idle speed over a start period and, in response to initiating the fueling event, commanding the valve control system to control the intake/exhaust valves of the cylinders to mitigate or eliminate NVH caused by engine jerk over the start period.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1C are plots of an example engine stop and start events using the conventional strategies according to the prior art;

FIG. 2 is a diagram of a vehicle having an engine with a valve control system configured to provide improved engine stop/start events according to the principles of the present application;

FIG. 3 is a flow diagram of an example valve control method for improved stop/start events of an engine of a vehicle according to the principles of the present application;

FIGS. 4A-4C are plots of an example engine stop and start events using the improved stop/start systems and methods according to the principles of the present application; and

FIG. 5A-5B are plots comparing example engine stop and start events using the conventional strategies to example stop and start events using the systems and methods according to the principles of the present application.

### DESCRIPTION

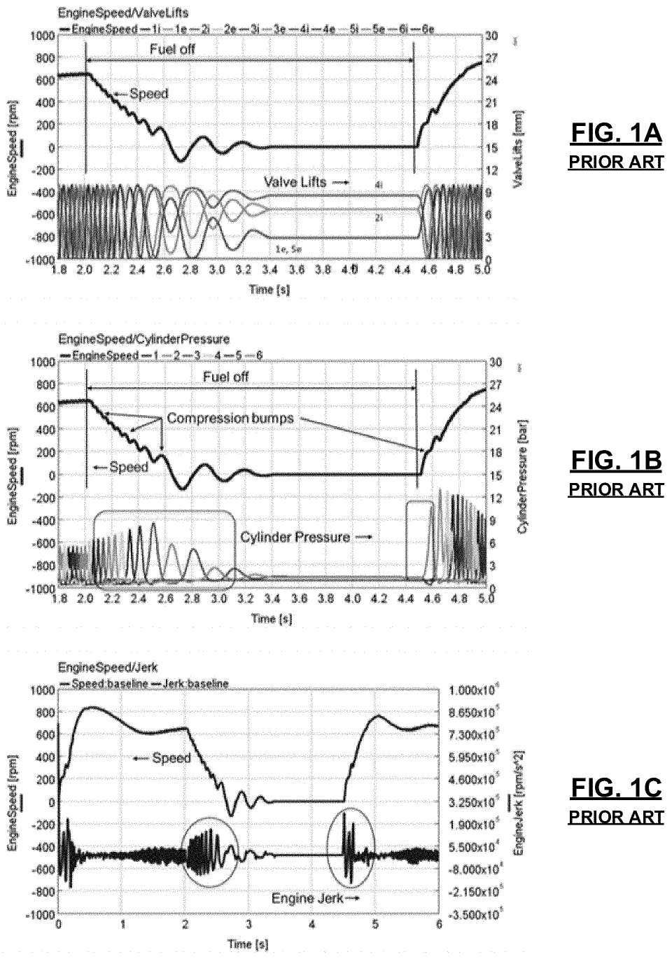

As previously discussed, because intake and exhaust valves continue moving during a fuel shutoff (FSO) event in conventional stop/start strategies, at least some cylinders experience an air-only intake and compression process. This compression causes a rise in cylinder gas pressure, and these “compression bumps” could result in noise/vibration/harshness (NVH) or engine jerk that is noticeable to a driver of the vehicle. FIGS. 1A-1C illustrate plots of an example six-cylinder engine stop event using these conventional strategies according to the prior art. In FIG. 1A, a FSO event is illustrated where engine speed gradually decreases and the intake/exhaust valves continue moving (varying lifts) until reaching a static or stoppage point until a subsequent engine start event. In FIG. 1B, the resulting spikes cylinder pressures (“compression bumps”) from air-only intake and combustion for engine stop and subsequent start events is illustrated. Lastly, in FIG. 1C, engine jerk corresponding to the cylinder pressure increases is focused on that causes the NVH (e.g., seat track vibration dose value, or VDV) for engine stop and subsequent start events.

Accordingly, valve control systems and methods for improved engine stop/start operation are presented. This valve control strategy could also be referred to as “full cylinder deactivation (FCD), low trap” referring to fully-deactivated cylinders (i.e., intake/exhaust valves fully-closed) and little or no gas trapped within the cylinders. In the proposed valve control strategy, during engine stop events (i.e., when FSO is initiated), the intake valves are required to close first followed by respective exhaust valves. Because any residual gas in the cylinders is exhausted on a final exhaust stroke when the respective exhaust valves are open, there is little or no residual air for the cylinders to compress during subsequent movements until the engine finally stops. This mitigates or eliminates the NVH/engine jerk associated with the above-described “compression bumps.” The same benefits will also be realized upon engine restarts where NVH/engine jerk could occur. This proposed valve control strategy could require additional valve control hardware (i.e., for full lift control), but some engines already include such valve control hardware and thus the proposed solution would provide these engine stop/start benefits without increasing costs.

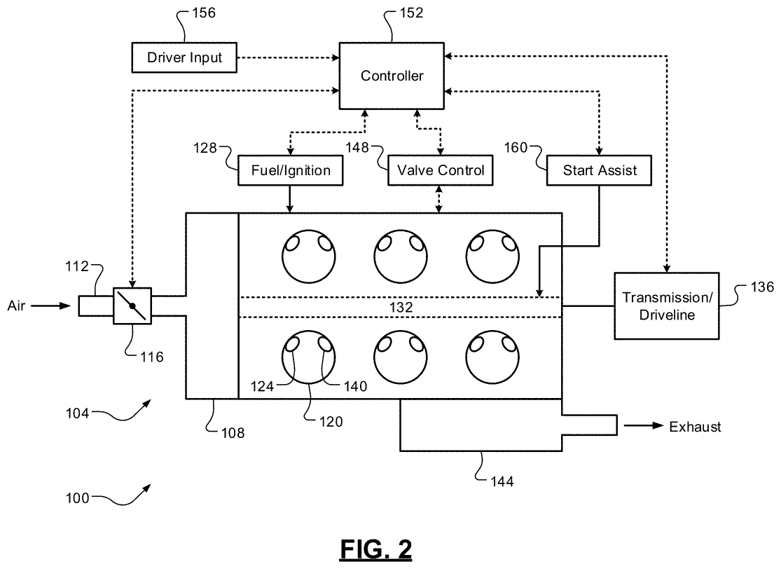

Referring now to FIG. 2, a diagram of a vehicle 100 comprising an engine 104 having an example valve control system for improved engine stop/start operation according to the principles of the present application is illustrated. The engine 104 draws air into an intake manifold 108 through an induction system 112 that is regulated by a throttle valve 116. The air in the intake manifold 108 is distributed to a plurality of cylinders 120 via respective intake valves 124 and combined with fuel (e.g., gasoline) from a fuel/ignition system 128. While six cylinders 120 are shown, it will be appreciated that the systems and methods of the present disclosure are applicable to any engine having a suitable number of cylinders (4, 8, 10, 12, etc.) and full valve lift control hardware.

The air/fuel mixture is compressed within the cylinders 120 by respective pistons (not shown) and ignited (e.g., by spark from the fuel/ignition system 128) to combust the compressed air/fuel mixture and drive the pistons to rotatably turn a crankshaft 132 and generate drive torque that is transferred to a transmission/driveline 136 of the vehicle for propulsion. Exhaust gas resulting from combustion is expelled from the cylinders 120 via respective exhaust valves 140 and into an exhaust system 144 that treats the exhaust gas to mitigate/eliminate emissions.

A valve control system 148 (e.g., an electro-hydraulically actuated system) controls lift of the intake and exhaust valves 120, 140. A controller 152 is configured to control operation of the vehicle 100, including primarily controlling the engine 104 (air via the throttle valve 116, fuel/spark via the fuel/ignition system 128, etc.) to achieve a desired amount of drive torque (e.g., based on a driver torque request, received via a driver input system 156 that could include an accelerator pedal, a brake pedal, and the like). The controller 152 is also configured to control operation of the valve control system 148 to achieve desired intake/exhaust valve lift profiles.

For the purposes of the present application, this primarily includes commanding of the valve control system 148 to close each exhaust valve 140 after the closure of its respective intake valve 124 and after the exhaust stroke of its respective cylinder 124. The terms “close” and “closing” as used herein generally refer to fully closing the intake valves 124 followed by fully closing the respective exhaust valves 140 for the remainder of the stop period until the engine stop event is complete. While lift is specifically discussed herein, it will be appreciated that the valve control system 148 could also control other aspects of valve control such as intake/exhaust valve timing. For the purposes of the present application, the engine 104 achieves stop/start functionality by disabling and enabling/re-enabling fueling thereby stopping and starting/restarting the engine 104.

However, a conventional 12 Volt (12V) battery powered engine starter provides insufficient torque for quickly starting/restarting the engine 104 such that the valve control aspects of the present application can be achieved. Thus, the engine 104 also includes another other stop/start device/system 160, such as for increased engine start/re-start torque assistance. Non-limiting examples of this device/system 160 include a motor-generator unit (MGU) (e.g., as part of a belt starter-generator (BSG) unit) or a powertrain electric motor, such as an electric motor arranged on a same axle as the engine 104 and the transmission 136.

The controller 152 controls the engine stop/start operation, primarily based on driver input via the driver input system 156. This could include, for example only, accelerator pedal and brake pedal inputs. For example, when the accelerator pedal is not depressed and the brake pedal is being depressed, an engine stop event could be initiated. Other parameters, such as vehicle speed, could also be taken into account. For example, the engine stop event could be limited to accelerator pedal off, brake pedal on, and vehicle speed equals zero or is less than a threshold (rolling stop/start scenarios). In addition to commanding a FSO event (for engine stop) or a fueling/refueling event (for engine start/restart), the controller 152 is also configured to control the valve control system 148 to achieve the control strategies according to the principles of the present application, which will now be described in greater detail.

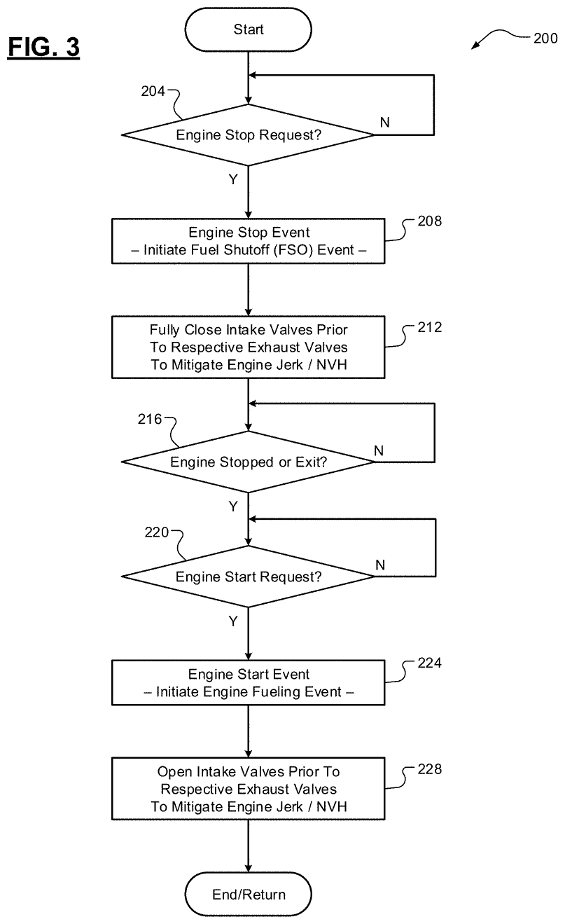

Referring now to FIGS. 3, 4A-4C, and 5A-5B and with continued reference to FIG. 2, an example valve control method 200 for improved engine stop/start control and various plots corresponding to this example method 200 are illustrated. While the components of FIG. 1 are specifically referenced for explanatory purposes, it will be appreciated that the method 200 could be applicable to any suitable engine employing stop/start and full valve lift control hardware. At 204, the controller 152 determines whether an engine stop event is requested. As previously discussed, this could be determined based on whether a specific set of driver inputs are satisfied. When true, the method 200 proceeds to 208. Otherwise, the method 200 ends or returns to 204. At 208, the controller 152 begins an engine stop event. More specifically, at 208, the controller 152 initiates an FSO event whereby fueling to the engine 104 is disabled and the engine 104 fully stops after a stop period and, at 212, the controller 152 then commands the valve control system 148 to close each intake valve 124 prior to closing its respective exhaust valve 140 to (i) expel any residual gases from the cylinders 120 during respective exhaust strokes prior to closing the respective exhaust valves 140 and (ii) prevent air-only intake and compression within the cylinders 120 during the stop period to thereby mitigate or eliminate NVH caused by the air-only intake and compression.

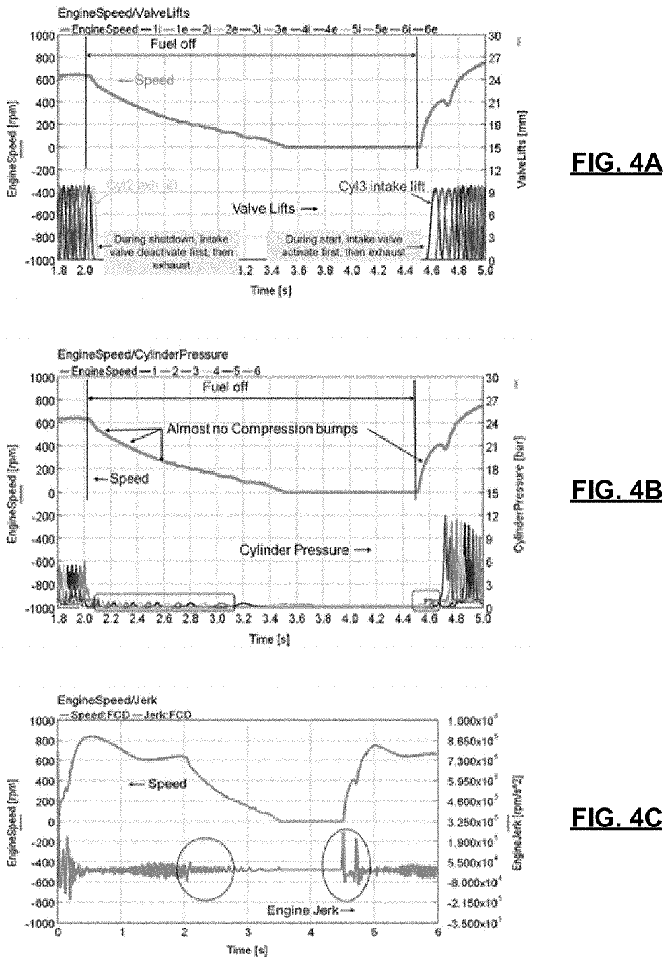

This is shown in the left portions of FIGS. 4A-4C (corresponding to the engine stop event, prior to the engine start/restart event). At 216, the controller 152 determines whether the engine stop event has completed (or a potential exit condition has been satisfied). The engine stop event completes when the engine speed reaches zero, but an exit condition could include the driver inputs changing (e.g., brake pedal off, accelerator pedal on) before the engine stop event completes, which could trigger an engine start/restart. When false, the method 200 returns to 216. When true, the method 200 proceeds to 220. At 220, the controller 152 determines whether an engine start/restart event is requested. As previously discussed, this could be determined based on whether a specific set of driver inputs are satisfied. When true, the method 200 proceeds to 224. Otherwise, the method 200 ends or returns to 220.

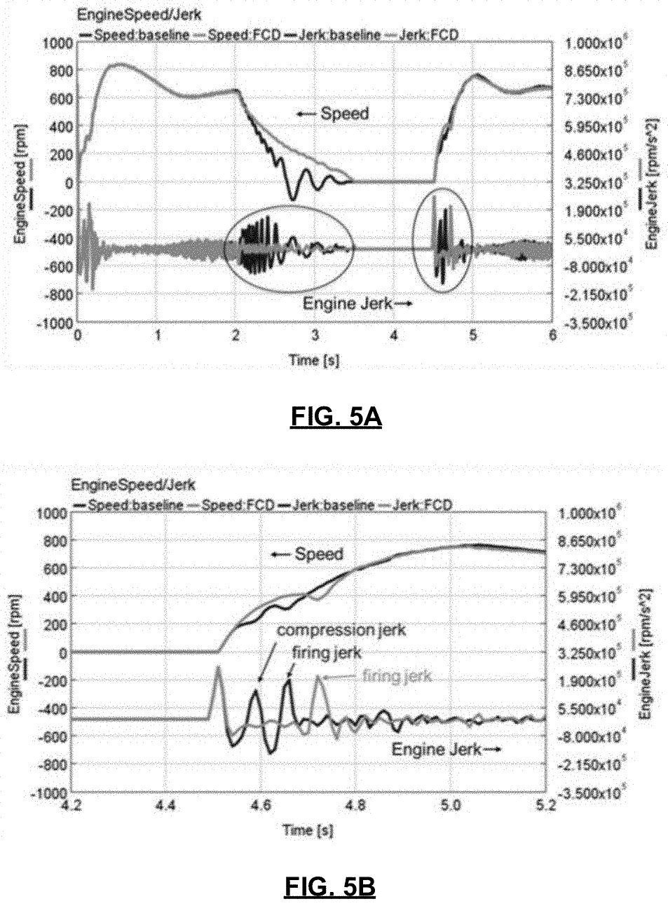

At 224, the controller 152 begins an engine start/restart event. More specifically, at 224, the controller 152 initiates a fueling event whereby fueling to the engine is enabled and the engine 104 starts and its speed increases to an idle speed over a start period and, at 228, the controller 152 then commands the valve control system 148 to control the intake/exhaust valves 124, 140 of the cylinders 120 to mitigate or eliminate NVH caused by engine jerk over the start period. Similar to the engine stop event, this could entail preventing air-only intake and compression within the cylinders 120 during the start period to thereby mitigate or eliminate NVH caused by the air-only intake and compression. This is generally shown in the right portions of FIGS. 4A-4C (corresponding to the engine start/restart event, after the engine stop event). FIGS. 5A-5B further illustrate comparisons between the conventional engine stop/start strategies and the improved engine stop/start strategies of the present disclosure, including the reduced NVH as a result. FIG. 5B, in particular, zooms in on the engine start/restart event to illustrate that while there is still engine jerk/NVH present during the engine start/restart event, it is still reduced via the control strategies of the present application. The method 200 then ends or returns to 204.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

1. A stop/start system for an engine of a vehicle, the stop/start system comprising:
a valve control system configured for full lift control of respective intake and exhaust valves of a plurality of cylinders of the engine; and
a controller of the engine configured to perform an engine stop event including:
initiating a fuel shutoff (FSO) event whereby fueling to the engine is disabled and the engine fully stops after a stop period, and
in response to initiating the FSO event, commanding the valve control system to close each intake valve prior to closing its respective exhaust valve to:
(i) expel any residual gases from the cylinders during respective exhaust strokes prior to closing the respective exhaust valves, and
(ii) prevent air-only intake and compression within the cylinders during the stop period to thereby mitigate or eliminate noise/vibration/harshness (NVH) caused by the air-only intake and compression.

2. The stop/start system of claim 1, wherein the commanding of the valve control system comprises closing each exhaust valve after the exhaust stroke of its respective cylinder.

3. The stop/start system of claim 1, wherein the commanding of the valve control system comprises fully closing the intake valves followed by fully closing the respective exhaust valves for the remainder of the stop period until the engine stop event is complete.

4. The stop/start system of claim 1, wherein the NVH is caused by engine jerk corresponding to cylinder pressure increases caused by the air-only intake and compression; and
wherein the controller is configured to command the valve control system to close every intake valve of the engine prior to closing every respective exhaust valve of the engine to prevent both (i) residual in-cylinder gases and (ii) air-only in-cylinder compression during subsequent exhaust strokes to thereby mitigate or eliminate NVH.

5. The stop/start system of claim 1, wherein the controller is further configured to perform an engine start event after the engine stop event by:
initiating a fueling event whereby fueling to the engine is enabled and the engine starts and its speed increases to an idle speed over a start period; and
in response to initiating the fueling event, commanding the valve control system to control the intake/exhaust valves of the cylinders to mitigate or eliminate NVH caused by engine jerk over the start period.

6. A valve control method for stop/start events of an engine of a vehicle, the method comprising:
providing a valve control system configured for full lift control of respective intake and exhaust valves of a plurality of cylinders of the engine; and
performing, by a controller of the engine, an engine stop event including:
initiating a fuel shutoff (FSO) event whereby fueling to the engine is disabled and the engine fully stops after a stop period, and
in response to initiating the FSO event, commanding the valve control system to close each intake valve prior to closing its respective exhaust valve to:
(i) expel any residual gases from the cylinders during respective exhaust strokes prior to closing the respective exhaust valves, and
(ii) prevent air-only intake and compression within the cylinders during the stop period to thereby mitigate or eliminate noise/vibration/harshness (NVH) caused by the air-only intake and compression.

7. The valve control method of claim 6, wherein the commanding of the valve control system comprises closing each exhaust valve after the exhaust stroke of its respective cylinder.

8. The valve control method of claim 6, wherein the commanding of the valve control system comprises fully closing the intake valves followed by fully closing the respective exhaust valves for the remainder of the stop period until the engine stop event is complete.

9. The valve control method of claim 6, further comprising commanding, by the controller, the valve control system to close every intake valve of the engine prior to closing every respective exhaust valve of the engine to prevent both (i) residual in-cylinder gases and (ii) air-only in-cylinder compression during subsequent exhaust strokes to thereby mitigate or eliminate NVH; and wherein the NVH is caused by engine jerk corresponding to cylinder pressure increases caused by the air-only intake and compression.

10. The valve control method of claim 6, further comprising performing, by the controller, an engine start event after the engine stop event by:
initiating a fueling event whereby fueling to the engine is enabled and the engine starts and its speed increases to an idle speed over a start period; and
in response to initiating the fueling event, commanding the valve control system to control the intake/exhaust valves of the cylinders to mitigate or eliminate NVH caused by engine jerk over the start period.
